(19) United States
(12) Patent Application Publication
(10) Pub. No.: US 2004/0251091 A1
(43) Pub. Date: Dec. 16, 2004

(54) Dual function brake system

(76) Inventor: William E. Archer, Mooresville, NC (US)

Correspondence Address: Attn: Stephen P. Evans, Esq., Marshall & Melhorn, LLC, Four SeaGate, 8th Floor, Toledo, OH, 43604, US

(21) Appl. No.: 10/729,241

(22) Filed: Dec. 5, 2003

Related U.S. Application Data
(60) Provisional application No. 60/432,516, filed on Dec. 11, 2002.

(51) Int. Cl. F16D 55/36

(52) U.S. Cl. 188/71.5

(57) ABSTRACT

An apparatus for braking comprises a fluid operated parking brake piston connected to a pressure plate with an axially extending portion and a radially extending portion. The radially extending portion is contacted on one side by at least one spring and is in selective contact with a brake pack on the other side. A method for braking comprises biasing the pressure plate into an axial direction when the pressurized fluid behind the parking brake piston is overcome by the at least one spring. The radial portion of the pressure plate is urged into the brake pack thus slowing the rotation of the rotors relative to the stators in the brake pack.

### RELATED APPLICATION

This application is claiming the benefit, under 35 U.S.C. § 119(e), of the provisional application filed on Dec. 11, 2002, under 35 U.S.C. § 111(b), which was granted Ser. No. 60/432,516, and is hereby incorporated by reference in its entirety.

### FIELD OF THE INVENTION

The present invention relates to a method and apparatus for braking comprising a dual function brake system.

### BACKGROUND OF THE INVENTION

Braking systems for various vehicle components utilizing a brake pack comprising a plurality of interleaved rotors and stators are well known in the art. Typically, such systems have at least one piston means for selectively compressing the rotors, attached to a rotating component of the vehicle, against one or more stators typically fixed to a non-rotating component of the vehicle.

For example, in U.S. Pat. Nos. 3,927,737 and 3,941,219, a service brake piston is reciprocally, non-rotatably mounted within a housing. A fluid actuator biases the piston toward a brake pack for engagement therewith. A parking brake piston is telescopingly nested within the service brake piston. A fluid retractor holds the parking brake piston in a disengaged position from the brake pack. A plurality of springs force the parking brake piston directly against the service brake piston, which engages the brake pack, in the absence of a predetermined pressure in the fluid retractor.

U.S. Pat. No. 4,263,991 provides for a brake pack comprising rotors and stators. One elongated stator is in direct contact with a first piston. The first piston is urged into the stator, thereby compressing the brake pack, by at least one spring. A second piston is also in contact with the elongated stator through an annular skirt. The annular skirt surrounds the disc pack. Pressurized fluid located adjacent the second piston urges the elongated stator away from the brake pack by overcoming the force of the spring behind the first piston.

U.S. Pat. No. 6,089,357 teaches separate and independently operated service and parking brake pistons selectively applied to opposite sides of a brake pack. In operation, pressurized fluid is provided on one side of the parking brake piston to oppose a spring on the opposite side of the piston. A decrease in the pressurized fluid allows the spring to force the parking brake piston into one side of the brake pack. The service brake piston located on the opposite side of the brake pack acts as a stop against the brake pack. Alternatively, pressurized fluid located adjacent the service brake piston urges the piston into one side of the brake pack for braking. The parking brake piston acts as a stop against the other side of the brake pack.

In light of the above designs, it would be advantageous to have a dual function brake system having a compact design facilitated by locating both the brake piston and service brake piston within a single housing on the same side of the brake pack and at least partially nesting one piston within the other. It would also be advantageous to locate the service brake piston and parking brake piston adjacent one another at the axle to improve brake performance and reliability by reducing the number of braking components required in the prior art.

### SUMMARY OF THE INVENTION

The present invention is directed toward a dual function brake system comprising a brake pack, a fluid pressure operated first piston for selective engagement with a first side of the brake pack and a fluid operated second piston, independently controlled from the first piston, also on the first side of the brake pack. At least one spring is located on a second side of the brake pack. A pressure plate, comprising an axial portion connected to the second piston and a radial portion in contact with both the at least one spring and the brake pack, is provided.

The present invention is also directed toward a method of braking comprising biasing the pressure plate in a first axial direction with the at least one spring and providing pressurized fluid adjacent the second piston to urge the piston and the pressure plate in a second axial direction. The pressure plate is urged into the brake pack to provide a braking force if the pressurized fluid is overcome by the at least one spring.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a partial front view of an embodiment of the present invention;

FIG. 1a is a partial detail view from FIG. 1;

FIG. 2 is a partial top view of the embodiment of the present invention depicted in FIG. 1;

FIG. 2a is a partial detail view from FIG. 2; and

FIG. 3 is a schematic view of a construction embodying the present invention.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

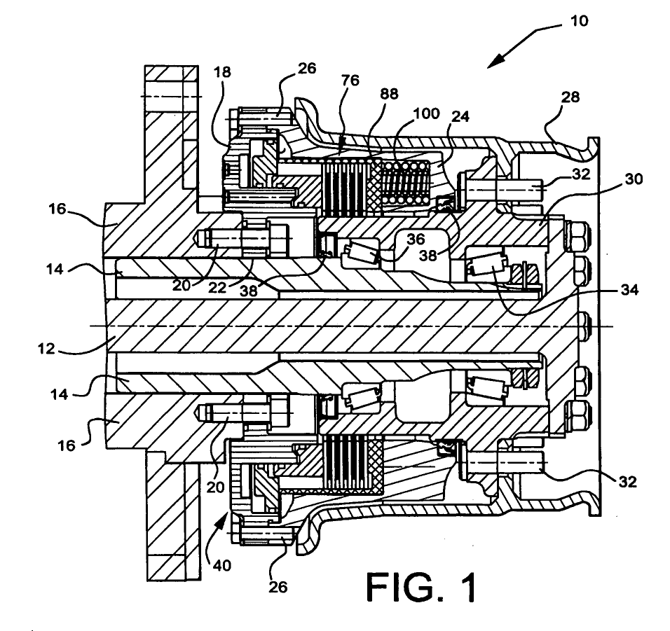

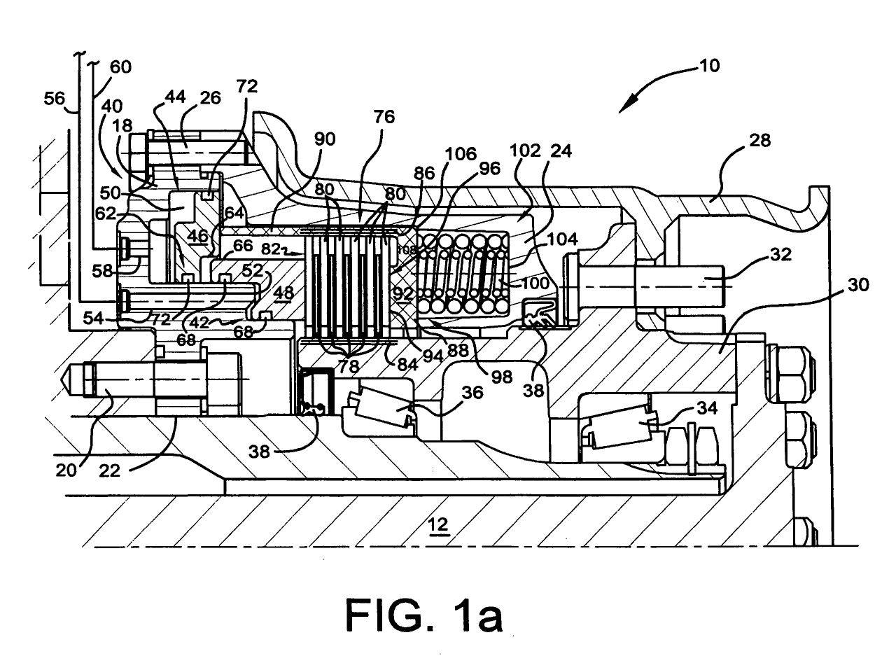

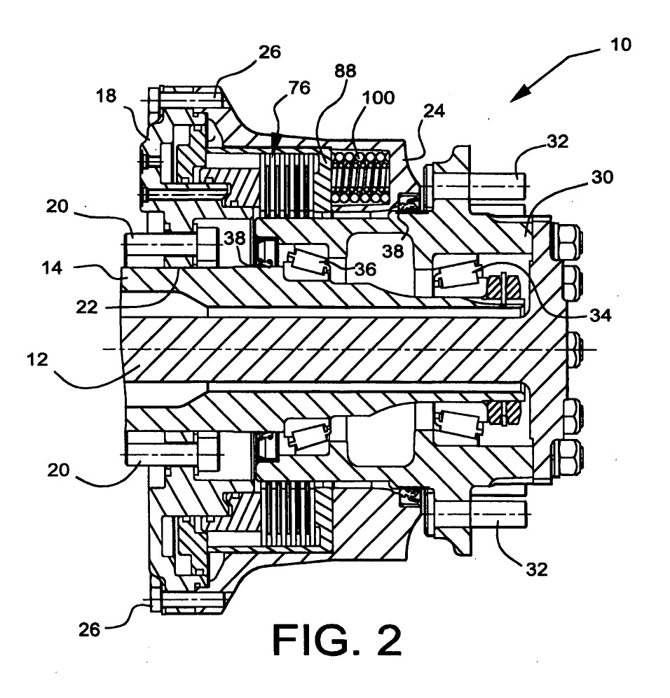

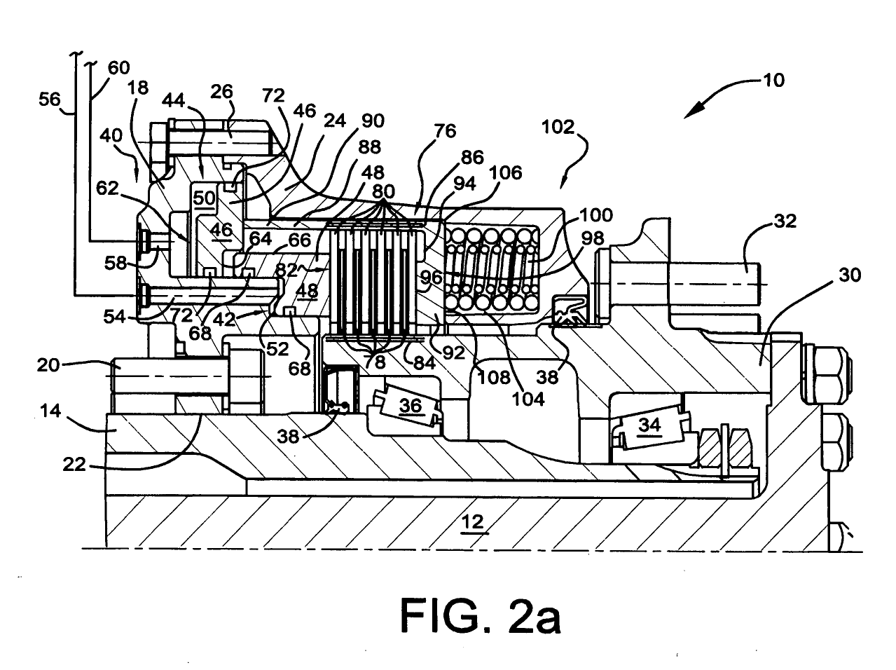

Referring now to FIGS. 1, 1a, 2, and 2a, a brake system 10 is depicted comprising a flanged axle shaft 12 at least partially located within a spindle 14. One end of both the axle shaft 12 and the spindle 14 are located within a housing 16 (not shown in FIG. 2 or 2a). A brake spider 18 is mounted to the housing 16 with at least two bolts 20 or other mechanical fasteners as known to those skilled in the art. The spider 18 has a central aperture 22 to allow both the axle shaft 12 and the spindle 14 to pass therethrough.

An axially extending brake housing 24 is attached to the spider 18 with one or more mechanical fasteners, such as bolts 26. In a preferred embodiment, a wheel mounting 28 (not shown in FIG. 2 or 2a) is located radially outward from the brake housing 24. The wheel mounting 28 is attached to a wheel hub 30 with one or more mechanical fasteners, such as bolts 32, as known to those skilled in the art. The wheel hub 30 is mounted on the spindle 14 with one or more bearings for rotational motion thereon. Preferably, an outer wheel bearing 34 and an inner wheel bearing 36 facilitate rotation of the wheel hub 30 with respect to the spindle 14. The outer wheel bearing 34 and the inner wheel bearing 36 may be tapered bearings, however, other bearings known to those skilled in the art may be used.

One or more seals 38 may be located between the rotating wheel hub 30 and the stationary brake housing 24 and/or the spindle 14 to prevent the transfer of lubricating fluid, such as oil, used in the brake system 10 as described in more detail below.

Preferably, one or more brake piston compartments are located at a radially outward portion 40 of the spider 18, as shown in FIGS. 1a and 2a. In a preferred embodiment, the radially outward portion 40 of the spider 18 provides for a service brake piston compartment 42 and a parking brake piston compartment 44. A parking brake piston 46 and a service brake piston 48 are located within each of the respective compartments 42, 44 and designed for axial movement therein. The parking brake piston 46 and the parking brake piston compartment 44 define a parking brake fluid chamber 50. The service brake piston 48 and the service brake piston compartment 42 define a service brake fluid chamber 52. At least one service brake fluid channel 54 is provided in the spider 18 for connection to a service brake fluid line 56. At least one separate parking brake fluid channel 58 is provided in the spider 18 for connection to a parking brake fluid line 60.

Preferably, the service brake piston 48 and the parking brake piston 46 have at least a partial complementary shape to one another. The complementary shape allows at least a portion of the parking brake piston 46 to receive at least a portion of said service brake piston 48.

In a preferred embodiment, a radially inward portion of the parking brake piston 62 has a cut-out 64. The service brake piston 48 has an axially extending lip 66 that has a complementary shape to the cut out 64. Axial movement of the parking brake piston 46 and/or the service brake piston 48 allows the lip 66 to be received within the cut out 64 or vice versa.

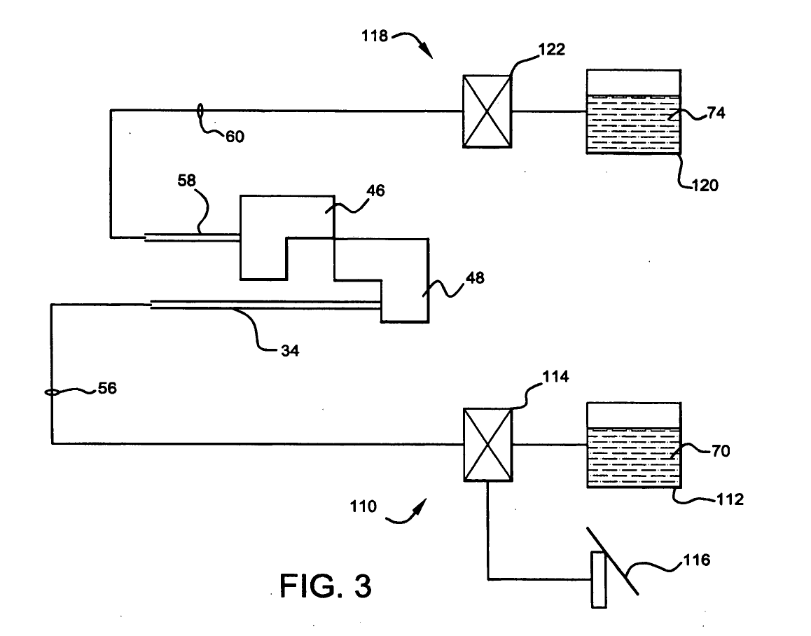

One or more seals 68 are located around the service brake piston 48 to prevent service brake fluid 70 (see FIG. 3) from communicating outside of the service brake fluid chamber 52. One or more seals 72 are also located around the parking brake piston 46 to prevent parking brake fluid 74 (see FIG. 3) from communicating outside of the parking brake fluid chamber 50.

A brake pack 76, comprising a plurality of rotating rotor discs 78 and a plurality of non-rotating stator discs 80 interleaved with the rotor discs 78, is provided adjacent the service brake piston 48, as shown in FIGS. 1a and 2a. Preferably, the service brake piston 48 is in direct contact with a first side 82 of the brake pack 76.

The rotor discs 78 are preferably mounted on a plurality of splines 84 located on the wheel hub 30 to facilitate axial movement along the wheel hub 30 as known to those skilled in the art.

The stator discs 80 are adapted for axial motion along a pressure plate 88. The stator discs 80 are preferably mounted on a plurality of splines 86 located along the pressure plate 88 to facilitate axial movement along the pressure plate 88 as known to those skilled in the art.

The pressure plate 88 comprises an axial portion 90 connected to the parking brake piston 46 and a radial portion 92. Preferably, the axial portion 90 is located radially outward from at least a portion of the service brake piston 48. The radial portion 92 preferably extends radially inward from an end of the axial portion 90. A first side of the radial portion 94 is in direct contact with a second side of the brake pack 96 and a second side of the radial portion 98 is in direct contact with at least one spring 100. The pressure plate 88 may be a one-piece construction or it may be a multi-piece construction.

At an axial end of the brake housing 102, at least one pocket 104 is provided for locating the at least one spring 100 therein. The spring 100 urges the pressure plate 88 in one axial direction and the parking brake piston 46 urges the pressure plate 88 in an opposite axial direction, as described in more detail below. A stop 106, located around the outer periphery of the pocket 108, prevents the parking brake piston 46 from compressing the spring 100 beyond a predetermined amount.

As schematically depicted in FIG. 3, a service brake system 110 comprises the service brake fluid line 56 connected with the service brake fluid channel 34 to a source for pressurized service brake fluid 112. The source 112 may have pressurization means and/or other fluid pressurization means known to those skilled in the art may be used. At least one service brake fluid valve 114 is preferably located between the service brake fluid channel 54 and the source for pressurized service brake fluid 112.

A service brake system activation means such as, for example, a brake pedal 116, as known to those skilled in the art, is used. The brake pedal 116 is in fluid, or electronic, communication with the at least one service brake fluid valve 114. The at least one service brake fluid valve 114 conditions modulates, increases, or decreases the service brake fluid 70.

FIG. 3 also schematically depicts a parking brake system 118 comprising the parking brake fluid line 60 connected with the parking brake fluid channel 58 to a source for pressurized parking brake fluid 120. The source 120 may have pressurization means and/or other fluid pressurization means known to those skilled in the art may be used. At least one parking brake fluid valve 122 is preferably located between the parking brake fluid channel 58 and the source for pressurized parking brake fluid 120. The at least one parking brake fluid valve 122 conditions, modulates, increase or decreases the parking brake fluid.

At least one sump or external cooling device known to those skilled in the art (not shown) is preferably located adjacent, on and/or within the brake system 10 to absorb heat generated by the above-described braking process. The device moves heat absorbed from the braking process away from the brake system 10.

In the method of using the present invention, a vehicle operator (not shown) selectively engages the brake pedal 116 when braking is desired, thus signaling the at least one service brake valve 114 to open. Pressurized service brake fluid 70 flows from the source 112, through the service brake fluid line 56 and then the service brake fluid channel 54 and into the service brake fluid chamber 52. The pressurized fluid 70 biases the service brake piston 48 into the first side of the brake pack 82. The rotors 78 and stators 80 slide axially along their respective splines 84, 86 and are compressed between the service brake piston 48 and the first side of the radial portion of the pressure plate 94. The compression creates an interfacing pressure between the rotors 78 and the stators 80 that slows the rotors 78 and thus the wheel hub 30. FIGS. 1, 1a, 2 and 2a depict the service brake piston 48 engaged with the brake pack 76.

When the desired amount of braking is complete, the operator releases the brake pedal 116, decreasing the amount of pressurized fluid 70 to the service brake piston 48. The service brake piston 48 is biased away from the brake pack 76 by the hydrodynamic fluid motion generated within the brake pack 76 once the rotors 78 begin to move again.

Preferably, under normal operating conditions, parking brake fluid 78 is continuously provided from the source for parking brake fluid 120, through the parking brake fluid line 60 and then the parking brake fluid channel 58 and into the parking brake fluid chamber 50. The parking brake fluid 74 biases the parking brake piston 46 into the axial portion 90 of the pressure plate 88. The parking brake piston 46 moves the pressure plate 88, including the radial portion 92, in the axial direction. The second side of the radial portion 98 compresses the at least one spring 100 until the stop 106 is engaged. In this orientation, the rotors 78 are free to rotate with respect to the stators 80, except when the service brake piston 48 engages the brake pack 76, as described above.

The parking brake can be engaged in at least two ways in the preferred embodiment. First, the operator can engage the parking brake by manually or automatically closing the parking brake valve 122, thereby reducing the amount of parking brake fluid 74 to the parking brake fluid chamber 50. When the parking brake fluid 74 in the parking brake fluid chamber 50 has been reduced to a predetermined amount, the spring 100 biases the pressure plate 88 in the axial direction. The rotors 78 and stators 80 slide axially along their respective splines 84, 86 and are compressed between the service brake piston 48 and the first side of the radial portion of the pressure plate 94. The compression causes an interfacing pressure between the rotors 78 and the stators 80 that slows the rotors 78 and thus the wheel hub 30.

The parking brake is released by manually or automatically opening the parking brake valve 122. The valve 122 allows a predetermined quantity of parking brake fluid 74 to be located adjacent the parking brake piston 46, thus moving the piston 46 and biasing the pressure plate 88 away from the brake pack 76. Removal of the pressure plate 88 from the brake pack 76 decompresses the stators 80 and rotors 78, allowing the rotors 78 to rotate adjacent the stators 80.

The second manner of engaging the parking brake is automatic. In normal operation of the preferred embodiment, a substantially constant quantity of parking brake fluid 74 is provided to the parking brake fluid chamber 50. As described above, the parking brake fluid 74 moves the parking brake piston 46 into contact with the pressure plate 88 thus biasing the pressure plate 88 away from the brake pack 76 against the at least one spring 100. In this mode, the rotors 78 can rotate with respect to the stators 80 in the brake pack 76.

If any component of the fluid driven parking brake system fails, or the means for pressurizing the parking brake fluid 74 fails to provide pressurized parking brake fluid 74 above a predetermined level to the parking brake fluid chamber 50, the at least one spring 100 biases the pressure plate 88 into the brake pack 76. In a preferred embodiment, the at least one spring 100 biases the radial portion 92 directly into the first side of the brake pack 82. The radial portion 92 compresses the rotors 78 and stators 80, thus increasing the interfacing pressure between them and slowing the rotation of the rotors 78 and therefore the wheel hub 30.

In accordance with the provisions of the patent statutes, the present invention has been described in what is considered to represent its preferred embodiments. However, it should be noted that the invention can be practiced otherwise than as specifically illustrated and described without departing from its spirit or scope.

I claim:

1. A brake system, comprising:
(a) a brake pack comprising a plurality of rotating rotor discs adapted for axial motion and a plurality of non-rotating stator discs interleaved with said rotor discs and also adapted for axial motion;
(b) a fluid pressure operated first piston for selective engagement with a first side of said brake pack for urging said stator and rotor discs into braking engagement;
(c) at least one spring on a second side of said brake pack for urging said stator discs and rotor discs into braking engagement;
(d) a fluid pressure operated second piston, independently controlled from said first piston, located on said first side of said brake pack; and
(d) a pressure plate comprising an axial portion connected to said second piston and a radial portion connected to said at least one spring.

2. The apparatus of claim 1, wherein said rotors are splined to a wheel hub for rotation therewith and for axial movement therealong.

3. The apparatus of claim 1, wherein said stators are splined to said pressure plate.

4. The apparatus of claim 1, wherein said at least one spring is located at least partially within at least one pocket within said housing, said pocket comprising a stop for said pressure plate.

5. The apparatus of claim 2, wherein said first piston and said second piston are located within a non-rotating brake spider.

6. The apparatus of claim 5, wherein said wheel hub is rotatably mounted with respect to said brake spider with at least one inner wheel bearing and at least one outer wheel bearing.

7. The apparatus of claim 6, wherein said first piston is a service brake piston in fluid communication with a service brake system comprising a brake pedal, a fluid reservoir and at least one fluid valve.

8. The apparatus of claim 7, wherein said second piston is a parking brake piston in fluid communication with a parking brake system, independent of said service brake system, comprising a fluid reservoir and at least one fluid valve.

9. The apparatus of claim 8, wherein said parking brake piston has at least a partial complementary shape to said service brake piston for selectively receiving at least a portion of said service brake piston.

10. The apparatus of claim 9, wherein said brake spider comprises a service brake fluid chamber for said service brake piston and a separate parking brake fluid chamber for said parking brake piston.

11. The apparatus of claim 10, wherein at least a portion of said axial portion of said pressure plate is located radially outward from at least a portion of said service brake piston.

12. The apparatus of claim 1, wherein said pressure plate is a one-piece construction.

13. The apparatus of claim 1, wherein said service brake piston selectively contacts said first side of said brake pack directly.

14. A method of braking, comprising:
providing a pressure plate comprising an axial portion and a radial portion;
connecting said axial portion of said pressure plate to a parking brake piston;
connecting said radial portion to a brake pack and also to at least one spring, said spring biasing said pressure plate in a first axial direction;
providing a pressurized fluid adjacent said parking brake piston to urge said pressure plate in a second axial direction; and
urging said radial portion of said pressure plate into said brake pack to provide a braking force if said pressurized fluid is overcome by said at least one spring.

15. The method of claim 14, wherein one side of said radial portion of said pressure plate is in direct contact with said brake pack and the other side of said radial portion is in direct contact with said at least one spring.

16. The method of claim 14, further comprising braking said brake pack by selectively urging a service brake piston directly into said brake pack.

17. The method of claim 16, wherein said braking comprises selectively locating fluid adjacent said service brake piston so that said piston compresses said brake pack into said radial portion of said pressure plate.

18. The method of claim 14, wherein urging said pressure plate in a second axial direction causes said radial portion to compress said at least one spring and release a plurality of rotors to rotate adjacent a plurality of stators in said brake pack.

19. The method of claim 14, further comprising preventing motion of said pressure plate in said second axial direction by abutting said pressure plate adjacent at least one stop comprising a housing for said at least one spring.

20. The method of claim 14, wherein said pressurized fluid is selectively provided adjacent said parking brake piston in a parking brake fluid chamber integrally formed with a brake spider.
